(19) United States
(12) Patent Application Publication
(10) Pub. No.: US 2013/0221664 A1
(43) Pub. Date: Aug. 29, 2013

(54) LASER WELDING STRUCTURE OF INTANK FILTER FOR MOTOR VEHICLE

(71) Applicant: COAVIS, (US)

(72) Inventor: Han Young KIM, Daejeon (KR)

(73) Assignee: COAVIS, Yeongi-gun (KR)

(21) Appl. No.: 13/765,770

(22) Filed: Feb. 13, 2013

(30) Foreign Application Priority Data
Feb. 24, 2012 (KR) 10-2012-0018752

(51) Int. Cl. F16L 13/02

(52) U.S. Cl. CPC F16L 13/02
USPC 285/288.1

(57) ABSTRACT

The present invention includes an intank filter that is a component of a fuel pump module which is installed within a fuel tank of a motor vehicle to supply fuel into an engine, and more particularly, to a laser welding structure of an intank filter for a motor vehicle, for joining the intank filter through laser welding.

### CROSS-REFERENCE TO RELATED APPLICATIONS

This application claims the priority of Korean Patent Application No. 10-2012-0018752 filed on Feb. 24, 2012, in the Korean Intellectual Property Office, the disclosure of which is incorporated herein by reference.

### BACKGROUND OF THE INVENTION

1. Field of the Invention

The present invention relates to an intank filter that is a component of a fuel pump module which is disposed in a fuel tank of a motor vehicle to supply fuel to an engine, and more particularly, to a laser welding structure of an intank filter for a motor vehicle, for joining the intank filter through laser welding.

2. Description of the Related Art

Vehicles that are driven by gasoline engines, diesel engines, or the like that receive liquid fuel include a fuel tank for storing the liquid fuel. Also, a fuel pump module for forcibly supplying liquid fuel filled in the fuel tank to the engine is provided in the fuel tank.

In general, a fuel pump module, as shown in FIGS. 1 and 2, may include a flange assembly 1, a reservoir body assembly 2, a guide rod 3 connecting the flange assembly 1 to the reservoir body assembly 2, a spring 4 disposed outside the guide rod 3, and an intank filter 5 for removing foreign substances contained in fuel.

In the majority of cases, the flange assembly 1 is fixed to an inlet of a fuel tank, and the reservoir body assembly 2 is disposed on the bottom of the fuel tank. The guide rod 3 may guide the movement of the spring 4 and simultaneously connect the flange assembly 1 to the reservoir body assembly 2. The guide rod 3 is slid into the reservoir body assembly 2. The spring 4 is disposed outside the guide rod 3 and between the flange assembly 1 and the reservoir body assembly 2 so that the reservoir body assembly 2 is always disposed on the bottom of the fuel tank.

The intank filter 5 includes an upper container and a lower container that are coupled to each other, and filter media installed inside the coupled upper and lower containers.

The upper container and the lower container are coupled to each other to serve as a pressure container. Each of the upper and lower containers is formed of a metal or a synthetic resin. In the case where each of the upper and lower containers is formed of metal, the surfaces of the upper and lower containers may be corroded. In addition, it is difficult to weld the upper and lower containers to each other, and manufacturing costs are expensive.

For these reasons, the upper and lower containers formed of the synthetic resin having low manufacturing costs and superior corrosion resistance are mainly being used.

In the related art, thermal fusion welding or ultrasonic welding is performed to join the upper and lower containers to each other. Recently, laser welding using a laser has been performed to improve joint completion and joint strength of the intank filter.

FIG. 3 is a view illustrating a laser welding structure of an intank filter using an existing laser. As shown in FIG. 3, only a lap joint may be allowable for laser welding. Thus, after one of an upper container 5a and a lower container 5b is fitted and fixed into the other, a laser welding part LW is formed by means of a laser to join the upper container 5a to the lower container 5b.

However, when compared to a butt joint achieved through the thermal fusion welding or ultrasonic welding according to the related art, the upper and lower containers 5a and 5b may be complicated in configuration. Also, if each of the upper and lower containers 5a and 5b are formed of a conductive plastic material, it may be difficult to perform bonding due to laser absorbency.

### SUMMARY OF THE INVENTION

An aspect of the present invention provides a laser welding structure of an intank filter for a motor vehicle in which upper and lower containers of the intank filter are joined to each other through laser welding, wherein the upper and lower containers are capable of being joined together through a butt joint using a joint member.

According to an aspect of the present invention, there is provided a laser welding structure of an intank filter for a motor vehicle, the laser welding structure including: an upper housing having an inner space and an opened lower portion; a lower housing having an inner space and an opened upper portion, the lower housing having an upper end contacting the upper housing to close the opened lower portion of the upper housing; and a joint member having a circular shape with a predetermined width to surround coupling surfaces of the upper and lower housings, wherein the upper housing and the joint member and the lower housing and the joint member are fixed and coupled to each other through laser welding.

The upper housing and the joint member may be laser-welded to define a closed curve along an outer circumferential surface of a lower end of the upper housing, and the lower housing and the joint member may be laser-welded to define a closed curve along an outer circumferential surface of an upper end of the lower housing.

The joint member may be formed of a material having laser permeability higher than those of the upper and lower housings.

A first separation prevention protrusion may protrude from the upper housing to contact one end of the joint member along the outer circumferential surface of the lower end of the upper housing, and a second separation prevention protrusion may protrude from the lower housing to contact the other end of the joint member along the outer circumferential surface of the upper end of the lower housing.

Each of the upper and lower housings may be formed of a resin composition which contains about 70 w % to about 99 w % of polyoxymethylene (POM) copolymer and about 1 w % to about 30 w % of at least one additive selected from the group consisting of carbon black and carbon fiber. The joint member may be formed of a POM copolymer.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view illustrating the entire structure of a fuel pump module;

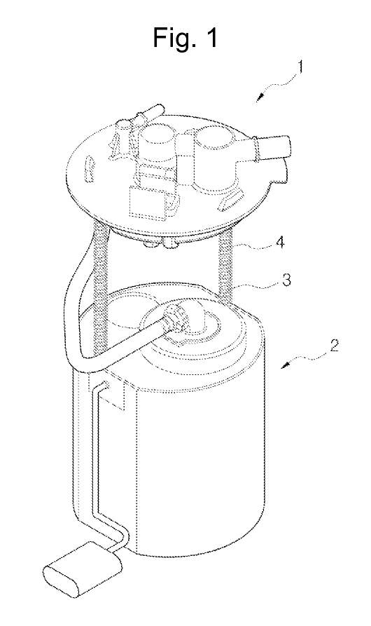

FIG. 2 is an exploded perspective view of the fuel pump module;

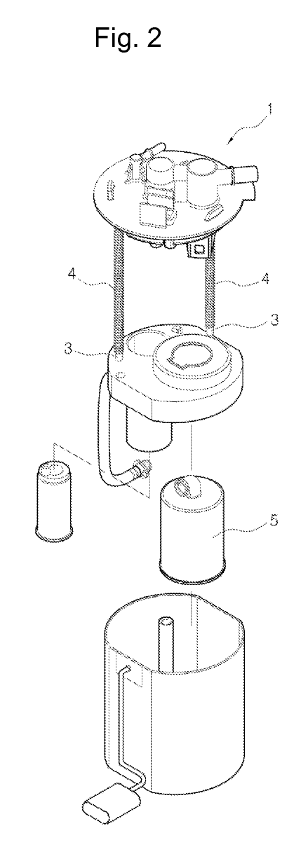

FIG. 3 is a cross-sectional view illustrating a laser welding structure of an intank filter according to a related art;

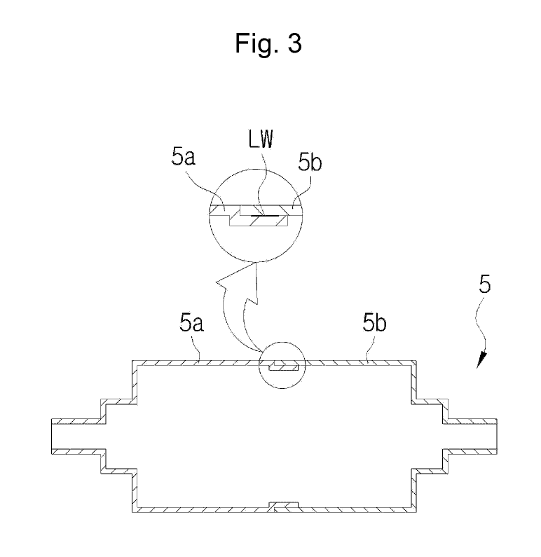

FIG. 4 is a schematic view illustrating a laser welding structure of an intank filter according to the present invention;

FIG. 5 is a cross-sectional view taken along line A-A′ of FIG. 4; and

FIG. 6 is a partial enlarged cross-sectional view illustrating the laser welding structure of the intank filter according to the present invention.

### DETAILED DESCRIPTION OF THE PREFERRED EMBODIMENT

Exemplary embodiments of the present invention will now be described in detail with reference to the accompanying drawings.

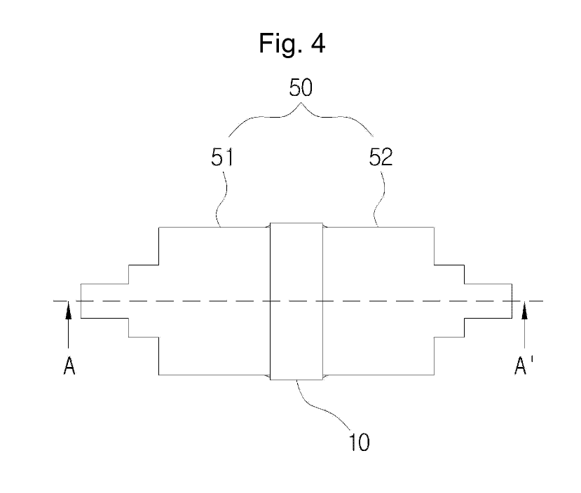

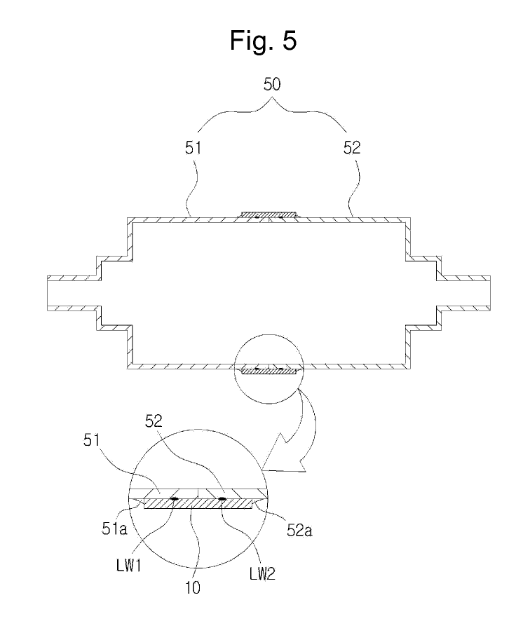

Referring to FIGS. 4 and 5, an intank filter 50 that is applied in a laser welding structure of an intank filter according to the present invention includes an upper housing 51 and a lower housing 52. Also, the laser welding structure of the intank filter further includes a joint member 10.

The intank filter 50 is constructed by coupling the upper housing 51 to be disposed at one side thereof to the lower housing 52 to be disposed at the other side thereof. A fuel discharge hole is defined in one side of the upper housing 51, and a fuel inflow hole is defined in the other side of the lower housing 51. The upper housing 51 has a cylindrical shape having an inner space. Also, the upper housing 51 has the other side that is opened. The lower housing 52 has a cylindrical shape having an inner space. Also, the lower housing 52 has one side opened. Thus, the other side of the upper housing 51 is coupled to the one side of the lower housing 52. That is, the upper housing 51 and the lower housing 52 are coupled to each other to seal an inner space of the intank filter 50. A filter media for filtering fuel may be disposed in the inner space. Since a component for filtering ordinary fuel is applied as the filter media, detailed descriptions with respect to the filter media will be omitted.

The other end of the upper housing 51 and one surface of the lower housing 52 contact each other to construct the intank filter 50. Hereinafter, the joint member 10 for joining the upper housing 51 to the lower housing 52 will be described in detail.

The joint member 10 has a circular shape. The joint member 10 is fitted into outer circumferential surfaces of coupling parts of the upper housing 51 and the lower housing 52. Particularly, the joint member 10 has a predetermined width to surround a predetermined area of an outer circumferential surface of the other end of the upper housing 51 and a predetermined area of an outer circumferential surface of one end of the lower housing 52. For example, a center of the width of the joint member 10 may be defined at an interface between the upper housing 51 and the lower housing 52.

Also, when the joint member 10 is fitted into the outer circumferential surfaces of the coupling parts of the upper housing 51 and the lower housing 52, the upper housing 51 and the lower housing 52, and the upper housing 51 and the lower housing 52 may be constructed as follows to prevent the joint member 10 from being separated. A first separation prevention protrusion 51a is disposed on the upper housing 51, and a second separation prevention protrusion 52a is disposed on the lower housing 52. The first separation prevention protrusion 51a protrudes outward from the outer circumferential surface of the other end of the upper housing 51 by a predetermined distance. When the joint member 10 is fitted into the upper housing 51, the first separation prevention protrusion 51a is disposed along the outer circumferential surface of the upper housing 51 so that the other end of the first separation prevention protrusion 51a contacts one end of the joint member 10. The first separation protrusion 51a may have a protruding length gradually increasing toward the other end thereof. The second separation prevention protrusion 52a protrudes outward from the outer circumferential surface of the one end of the lower housing 52 by a predetermined distance. When the joint member 10 is fitted into the lower housing 52, the second separation prevention protrusion 52a is disposed along the outer circumferential surface of the lower housing 52 so that the one end of the second separation prevention protrusion 52a contacts the other end of the joint member 10. The second separation protrusion 52a may have a protruding length gradually increasing toward the other end thereof.

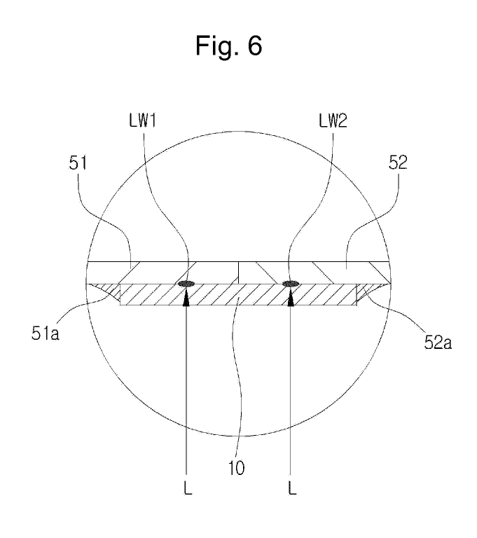

Referring to FIG. 6, the joint member 10 and the upper housing 51 may be welded and fixed through a first laser welding part LW1 by using a laser L. The first laser welding part LW1 is disposed on a portion at which the joint member 10 and the upper housing 51 contact each other. Also, the first laser welding part LW1 may define a closed curve along the outer circumferential surface of the upper housing 51. The first laser welding part LW1 may be disposed on a portion that is spaced a predetermined distance from the one end of the joint member 10 in the other side direction. The first laser welding part LW1 may be disposed on a portion that is spaced a predetermined distance from the other end of the upper housing 51 in one side direction.

Also, the joint member 10 and the lower housing 52 may be welded and fixed through a second laser welding part LW2 by using the laser L. The second laser welding part LW2 is disposed on a portion at which the joint member 10 and the lower housing 52 contact each other. Also, the second laser welding part LW2 may define a closed curve along the outer circumferential surface of the lower housing 52. The second laser welding part LW2 may be disposed on a portion that is spaced a predetermined distance from the other end of the joint member 10 in one side direction of FIG. 6. The second laser welding part LW2 may be disposed on a portion that is spaced a predetermined distance from the one end of the lower housing 52 in the other side direction FIG. 6.

Thus, the upper housing 51 and the lower housing 52 may not be directly fixed with respect to each other, but be coupled through the joint member 10 by the laser welding.

Here, the joint member 10 may be constructed as follows for easy laser welding. The joint member 10 may be formed of a material having laser permeability higher than those of the upper and lower housings 51 and 52. Thus, when the laser is emitted onto the joint member 10 and the coupling part of the upper housing 51, the laser may permeate the joint member 10 to melt an outer surface of the upper housing 51, to thereby join the joint member 10 to the upper housing 51.

Typically, each of the upper and lower housings 51 and 52 maybe formed of a resin material or conductive plastic. For example, each of the upper and lower housings 51 and 52 may be formed of a resin composition which contains (1) about 70 w % to about 99 w % of polyoxymethylene (POM) copolymer and (2) about 1 w % to about 30 w % of carbon black or carbon fiber additive. The additive may include a mixture of the carbon black and the carbon fiber.

The POM copolymer may be any POM copolymer well-known in the art. The POM copolymer may include KEPITAL POM-based POM copolymer supplied by Korea Engineering Plastics Co., Ltd., for example, F10-03, F20-03, or F30-03. The resin composition may include ET-20A or FA-20 supplied by Korea Engineering Plastics Co., Ltd.

The joint member 10 may be formed of a resin material. For example, the resin material may be a POM copolymer. The POM copolymer may be any POM copolymer well-known in the art. The POM copolymer may include KEPITAL POM-based POM copolymer supplied by Korea Engineering Plastics Co., Ltd., for example, F10-03, F20-03, or F30-03.

As described above, when the upper and lower housings 51 and 52 are fitted into the joint member 10 and then the laser is emitted onto the first and second laser welding parts LW1 and LW2, the laser transmits the joint member 10 that is a permeable layer to reach the upper and lower housing 51 and 52 that are laser absorbing layers. Thus, heat is generated in the upper and lower housing 51 and 52, and the generated heat is conducted into the joint member 10.

When heat is generated between the joint member 10 and the upper and lower housings 51 and 52, the joint member 10 and the upper and lower housings 51 and 52 are melted. Thereafter, the joint member 10 and the upper and lower housings 51 and 52 are solidified and joined to each other. Since the joint member 10 is formed of a thermoplastic resin having a transmittance of about 20% to about 80& or more at a near infrared (NIR) wavelength range (laser beam wavelength range), the laser welding process may be easily applied.

According to the laser welding structure of the intank filter for a motor vehicle of the present invention, the intank filter may have a high joint completion and joint strength due to the laser welding and also improved productivity because the upper and lower housings are simplified in configuration through the butt joint. In addition, since the upper and lower housings are laser-welded through the joint member, the upper and lower housings may not be limited in material.

The technical scope of the present invention is not limited to the above embodiments. It will be apparent to those skilled in the art that modifications and variations can be made without departing from the spirit and scope of the invention as defined by the appended claims. Thus, it is intended to cover all such changes and modifications by the appended claims that will be self-evident to a person of skill in the art.

What is claimed is:

1. A laser welding structure of an intank filter for a motor vehicle, the laser welding structure comprising:
an upper housing having an inner space and an opened lower portion;
a lower housing having an inner space and an opened upper portion, the lower housing having an upper end contacting the upper housing to close the opened lower portion of the upper housing; and
a joint member having a circular shape with a predetermined width to surround coupling surfaces of the upper and lower housings,
wherein the upper housing and the joint member and the lower housing and the joint member are fixed and coupled to each other through laser welding, and
wherein the joint member is formed of a material having laser permeability higher than those of the upper and lower housings.

2. The intank filter of claim 1, wherein the upper housing and the joint member are laser-welded to define a closed curve along an outer circumferential surface of a lower end of the upper housing, and
the lower housing and the joint member are laser-welded to define a closed curve along an outer circumferential surface of an upper end of the lower housing.

3. The laser welding structure of claim 2, wherein a first separation prevention protrusion protrudes from the upper housing to contact one end of the joint member along the outer circumferential surface of the lower end of the upper housing, and
a second separation prevention protrusion protrudes from the lower housing to contact the other end of the joint member along the outer circumferential surface of the upper end of the lower housing.

4. The laser welding structure of claim 1, wherein each of the upper and lower housings is formed of a resin composition which contains about 70 w % to about 99 w % of polyoxymethylene (POM) copolymer and about 1 w % to about 30 w % of at least one additive selected from the group consisting of carbon black and carbon fiber.

5. The laser welding structure of claim 1, wherein the joint member is formed of a POM copolymer.
